(19) United States
(12) Patent Application Publication
(10) Pub. No.: US 2009/0091182 A1
(43) Pub. Date: Apr. 9, 2009

(54) IMAGE FORMATION APPARATUS CAPABLE OF RECEIVING POWER FROM A PLURALITY OF POWER SOURCES AND CONTROL METHOD PERFORMED IN SUCH IMAGE FORMATION APPARATUS

(75) Inventors: Takeshi TAMADA, Toyohashi-shi (JP); Mikiyuki AOKI, Toyohashi-shi (JP); Kenji TAMAKI, Toyohashi-shi (JP); Masahiro ANAZAWA, Toyohashi-shi (JP); Morio KINOSHITA, Toyokawa-shi (JP)

Correspondence Address: MORRISON & FOERSTER LLP, 1650 TYSONS BOULEVARD, SUITE 400, MCLEAN, VA, 22102, US

(73) Assignee: KONICA MINOLTA BUSINESS TECHNOLOGIES, INC., Tokyo (JP)

(21) Appl. No.: 12/245,315

(22) Filed: Oct. 3, 2008

(30) Foreign Application Priority Data
Oct. 4, 2007 (JP) 2007-260967

(51) Int. Cl. H04B 3/54

(52) U.S. Cl. 307/2

(57) ABSTRACT

A power supply unit selects one of drive power provided from an AC/DC conversion unit and that provided from a separation unit and outputs the selected drive power to a control unit and a transmission and reception unit continuously. If the AC/DC conversion unit and the separation unit both supply their respective drive powers, the drive power that has a higher voltage value, i.e., the first drive power, is selectively output. When the first drive power supplied is stopped, a diode transitions from the on state to the off state and a diode transitions from the off state to the on state. As a result the second drive power is selectively output.

This application is based on Japanese Patent Application No. 2007-260967 filed with the Japan Patent Office on Oct. 4, 2007, the entire content of which is hereby incorporated by reference.

### BACKGROUND OF THE INVENTION

1. Field of the Invention

The present invention relates generally to image formation apparatuses capable of receiving power from a plurality of power sources and control methods performed in the image formation apparatuses, and particularly to configurations capable of receiving power via communication line.

2. Description of the Related Art

In recent years there has been proposed a configuration supplying a networked device with power through a communication line transmitting and receiving a communication signal (or a data signal). Such configuration is noted as a method of supplying power for driving Internet Protocol (IP) telephones, wireless access points, network cameras, and the like in particular. As a representative example of a network configuration equipped with a power supplying function as described above is established Institute of Electrical and Electronic Engineers (IEEE) 802.3af IEEE 802.3af is a standard for supplying predetermined direct-current (DC) power via a communication line used for Ethernet. It is also referred to as Power over Ethernet (PoE). Furthermore, there also exists a power supply system referred to as a universal serial bus (USB) bus power system for a USB standard mainly for connecting a body of a computer and peripheral equipment.

In recent years, as there is an increasing concern about environmental issues, approaches have been made to reduce power consumed by a variety of apparatuses. For example Japanese Laid-Open Patent Publication No. 2005-250739 discloses electronic equipment that can reduce that cumbersomeness of operating both a power supply of a host device and that of the equipment in connecting to the host device via a connection cable without increasing power consumed by the equipment when it is powered off. Furthermore Japanese Laid-Open Patent Publication No. 2003-158529 discloses a power supply control system in a LAN device including a plurality of LAN ports and a plurality of power supply ports supplying power to a shared device configuring a LAN. In this power supply control system when there is not a link formed between the shared device and all clients, power supplied to the shared device connected to the power supply port is stopped.

Furthermore, as one such attempt to reduce power consumption, as described above, there can be discussed a power supply management system for example for an office in which business equipment is supposed to be used only within predetermined business hours. More specifically, after all users have left the office (e.g., at night), the system entirely stops supplying the office with electric power.

If there is in the office a facsimile device or a similar device communicating data with an external device, however, it is necessary to maintain the facsimile or similar device in a status allowing the device to be constantly capable of receiving data. It is thus difficult to entirely stop supplying the office with power supply. Furthermore the above prior art documents only disclose a configuration based on a state in which main power supply is externally supplied, and cannot resolve such a problem as above.

### SUMMARY OF THE INVENTION

The present invention has been made to overcome such disadvantage, and it contemplates an image formation apparatus capable of continuing to communicate data with another apparatus if external power received from an external power source is interrupted, and a control method performed in the image formation apparatus.

The present invention in one aspect provides an image formation apparatus configured to be capable of communicating data via a communication line with an external device capable of supplying power via the communication line. The image formation apparatus includes a power load unit, a control unit, a power conversion unit, a separation unit, a transmission and reception unit, and a power supply unit. The power load unit performs a process involved in forming an image. The control unit controls the power load unit. The power conversion unit converts external power received from an external power source into first drive power. The separation unit is connected to the communication line, and separates a communication signal and supplied power flowing through the communication line and outputs the separated supplied power as second drive power. The transmission and reception unit transmits and receives the communication signal. The power supply unit continuously supplies at least the control unit and the transmission and reception unit with one of the first drive power and the second drive power.

Preferably, the power supply unit selects and outputs one of the first drive power and the second drive power that has a higher voltage value.

Still preferably, the power supply unit includes: a voltage conversion unit converting one of the first drive power and the second drive power to a predetermined voltage; a first diode provided in a path inputting the first drive power to the power conversion unit, the first diode being provided in a forward direction; and a second diode provided in a path inputting the second drive power to the power conversion unit, the second diode being provided in a forward direction, and the first drive power has a rated voltage value higher than that of the second drive power.

Preferably, the power supply unit further includes a status detection unit detecting a status of the first drive power and that of the second drive power, and the control unit changes a mode of operation of the image formation apparatus in accordance with the status of the first drive power and that of the second drive power.

Still preferably, the power load unit is configured to be operable on the first drive power provided from the power supply unit, and the control unit enables the power load unit to operate when the first drive power is supplied.

Furthermore, still preferably, when the first drive power and the second drive power are both supplied, the control unit permits shifting to a low power consumption mode, and after shifting to the low power consumption mode, stops a power conversion operation in the power conversion unit.

Furthermore, still preferably, the control unit includes a storage unit storing data, and when the transmission and reception unit receives a print instruction via the communication line and the first drive power is also supplied the control unit enables the power load unit to operate to perform a process in accordance with the print instruction, whereas when the transmission and reception unit receives a print instruction via the communication line and the first drive power is not supplied the control unit stores the print instruction to the storage unit.

Still preferably, the image formation apparatus is connected to be capable of communicating data with another image formation apparatus via the communication line, and when the print instruction is stored in the storage unit, the control unit conducts a search for another image formation apparatus connected to be capable of communicating data that is capable of an image formation process, and the control unit transfers the print instruction stored in the storage unit to an image formation apparatus retrieved by the search.

The present invention in another aspect provides a control method performed in an image formation apparatus configured to be capable of communicating data via a communication line with an external device capable of supplying power via the communication line. The image formation apparatus includes a power load unit, a power conversion unit, a control unit, a separation unit, a transmission and reception unit, and a power supply unit. The power load unit performs a process involved in forming an image. The control unit controls the power load unit. The power conversion unit converts external power received from an external power source into first drive power. The separation unit is connected to the communication line, and separates a communication signal and supplied power flowing through the communication line and outputs the separated supplied power as second drive power. The transmission and reception unit transmits and receives the communication signal. The power supply unit continuously supplies at least the control unit and the transmission and reception unit with one of the first drive power and the second drive power. The control method includes the steps of: obtaining by the control unit a status of the first drive power and that of the second drive power; and changing by the control unit a mode of operation of the image formation apparatus in accordance with the status of the first drive power and that of the second drive power.

Preferably, the power load unit is configured to be operable on the first drive power provided from the power supply unit and the step of changing includes the step of enabling the power load unit to operate when the first drive power is supplied.

Preferably, the step of changing includes the step of permitting shifting to a low power consumption mode when the first drive power and the second drive power are both supplied, and after shifting to the low power consumption mode, stopping a power conversion operation performed by the power conversion unit.

Preferably, the control unit includes a storage unit storing data, and the control method further includes the step of enabling the power load unit to operate to perform a process in accordance with a print instruction when the transmission and reception unit receives the print instruction via the communication line and the first drive power is also supplied, whereas storing a print instruction to the storage unit when the transmission and reception unit receives the print instruction via the communication line and the first drive power is not supplied.

Still preferably, the image formation apparatus is connected to be capable of communicating data with another image formation apparatus via the communication line, and the control method further includes the step of, when the print instruction is stored in the storage unit, conducting a search for another image formation apparatus connected to be capable of communicating data that is capable of an image formation process, and transferring the print instruction stored in the storage unit to the image formation apparatus retrieved by the search.

Thus in accordance with the present invention if external power provided from an external power source is interrupted data communication with another apparatus can still be continued.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 shows an appearance of an image formation apparatus according to a present embodiment.

FIG. 2 is a block diagram showing a configuration in function of the formation apparatus according to the present embodiment.

FIG. 3 is a block diagram schematically showing a configuration of a power supply unit according to the present embodiment.

FIG. 4 indicates a status of power and a status of each unit in the image formation apparatus according to the present embodiment.

FIG. 5 is a block diagram showing a configuration in function in a control unit according to the present embodiment.

FIG. 6 is a flowchart of a procedure of a process performed in the image formation apparatus according to the present embodiment.

FIG. 7 is a diagram schematically showing an application of the image formation apparatus according to the present embodiment.

### DESCRIPTION OF THE PREFERRED EMBODIMENTS

The present invention in an embodiment will now be described with reference to the drawings. In the figures, identical or like components are identically denoted and will not be described repeatedly.

Configuration of Image Formation Apparatus

The present invention is directed to an image formation apparatus connected to a network capable of communicating data and supplying power via a single communication line. In the present embodiment a multi function peripheral (MFP) equipped with a plurality of functions such as a copy function, a print function, a facsimile function and a scanner function will be described as a representative example of the present image formation apparatus. Furthermore a configuration adopting the PoE system established as IEEE802.3af will be described as a representative example of the network capable of communicating data and supplying power via a single communication line.

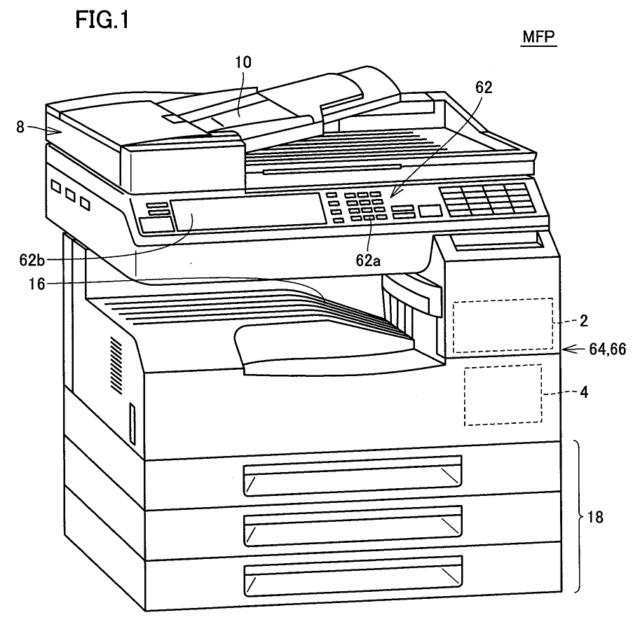

With reference to FIG. 1, the present embodiment provides an image formation apparatus MFP including a control unit 2, a power conditioning unit 4, an image reading unit 8, an automatic document feeding unit 10, a sheet feeding unit 18, a manipulation unit 62, a sensor unit 64, and a drive unit 66. Note that manipulation unit 62, sensor unit 64 and drive unit 66 configure a print engine load unit 6 operating, driving and the like a print engine (not shown) for performing a process involved in forming an image. (Hereinafter this process will also generally be referred to as a “print process”.) They correspond to a power load unit.

Automatic document feeding unit 10 is a unit for reading a document successively. It is configured of a document feeding tray, a feeding roller, a registration roller, a transport drum, a document receiving tray (all not shown) and the like. When a user manipulates manipulation unit 62 to enter a start instruction, automatic document feeding unit 10 feeds documents placed on the document feeding tray to be read, one by one as the feeding roller operates.

Image reading unit 8 emits light from a source of light toward a passing document to expose it to light and receives a reflection of the light from the document by a pickup device or the like to read image information of the document. Note that image reading unit 8 can also read image information from a document placed on a platen glass. The image information read by image reading unit 8 is transmitted to an image processing unit to undergo a predetermined image process and is thus converted to image data and thereafter transmitted to the print engine.

The print engine forms an image from the image data on a sheet. More specifically, the print engine includes a photoreceptor drum, a charger, an image writing unit (or an exposure unit), a development unit, a transcription unit, a discharger, a fuser and fixer device, a cleaning unit and the like (all not shown). These mechanisms operate in a series to implement the print process. Furthermore sensor unit 64 includes a plurality of sensors for detecting a status of each mechanism in manipulation unit 62, a sensor for detecting how a sheet is transported, a sensor for detecting the temperature of a surface of a heating roller in the fuser and fixer device, and the like. Drive unit 66 includes a motor for rotating the photoreceptor drum and a variety of types of rollers and the like, a laser drive unit driving the exposure unit and the like.

Sheet feeding unit 18 includes at least one sheet feeding cassette. It is synchronized with the print process in the print engine to feed by a roller or the like a sheet set in a predetermined sheet feeding cassette.

Control unit 2 operates in response to a variety of instructions received via an input key 62a in manipulation unit 62 to control the print engine and/or cause a display unit 62b or the like to display a variety of information. Note that input key 62a includes a start button pressed to indicate that the print process should start, numeral keys used to enter characters, numbers and the like, and the like. Display unit 62b is representatively configured for example of a liquid crystal display (LCD). Furthermore, control unit 2 changes a mode of operation of image formation apparatus MFP in accordance with a status of power supplied from external power sources, as will be described later.

Power conditioning unit 4 is a unit for supplying control unit 2, print engine load unit 6 and the like with power. In particular, the present embodiment provides image formation apparatus MFP that receives power supplied from a plurality of external power sources and thus operates thereon, and hereinafter a configuration receiving external alternate-current (AC) power from an electric power system or the like and external DC power supplied via a communication line will be illustrated. The former power and the latter power will hereinafter also be referred to as “commercial power” and “network power”, respectively. Note that the image formation apparatus may be adapted to receive more types of external power other than the two types of power exemplified in the present embodiment. Power conditioning unit 4 supplies one of the commercial power and the network power to at least control unit 2 and a transmission and reception unit 34 continuously.

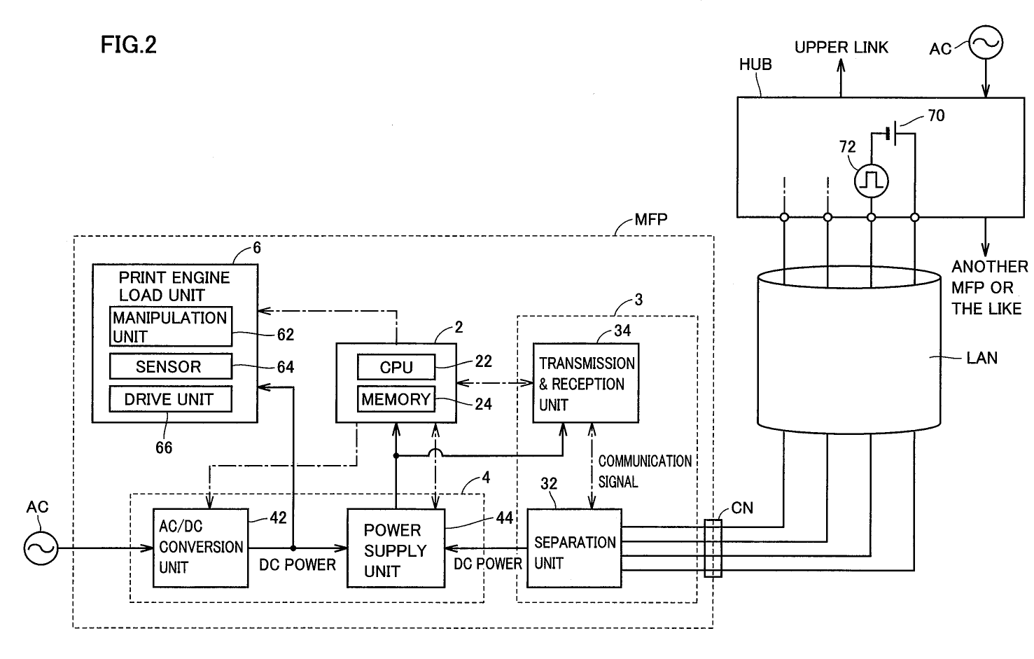

With reference to FIG. 2, in the present embodiment, image formation apparatus MFP is connected via a connector CN to a communication line LAN and also via communication line LAN to a hub device HUB equipped with a power supplying function. Another image formation apparatus MFP, a personal computer and the like are also connected to hub device HUB, and image formation apparatus MFP can communicate data with hub device HUB, another image formation apparatus MFP, the personal computer and the like.

As has been described previously, hub device HUB is equipped with a power supplying function in accordance with the PoE system. As one example, hub device HUB includes a DC voltage supply 70 and an oscillator 72 connected in series to a pair of communication lines LAN. DC voltage supply 70 is a power source for supplying power and applies a predetermined voltage to the pair of communication lines LAN. Note that according to IEEE 802.3af, it supplies DC power having a voltage value of 48 V. Oscillator 72 superposes on the pair of communication lines LAN a pulsing communication signal (or a data signal) used in communicating data. By such configuration, communication line LAN will include DC network power and a pulsing (or AC) communication signal.

To accommodate this, image formation apparatus MFP in the present embodiment further includes an interface unit 3 connected to communication line LAN. More specifically, interface unit 3 includes a separation unit 32 and transmission and reception unit 34.

Power conditioning unit 4 includes an AC/DC conversion unit 42 and a power supply unit 44. AC/DC conversion unit 42 is a power conversion unit receiving commercial AC power from a power supply system AC and converting the received power to DC power, and including a power transistor or a similar switching device representatively. AC/DC conversion unit 42 outputs the produced DC power as first drive power to power supply unit 44.

Separation unit 32 separates the communication signal and the network power flowing on communication line LAN from each other. Separation unit 32 is configured including a frequency filer representatively, and outputs a DC component of an electrical signal that propagates on communication line LAN as the network power, and an AC component of the electrical signal as a communication signal. The network power separated by separation unit 32 is output as second drive power to power conditioning unit 4 and received by power supply unit 44. Furthermore, transmission and reception unit 34 receives the communication signal separated by separation unit 32. More specifically, transmission and reception unit 34 generates a communication signal in accordance with data received from control unit 2 for transmission and also decodes a communication signal that is received from separation unit 32 into received data and outputs the data to control unit 2. Note that on a pair of communication lines LAN a bidirectional communication signal may be propagated or a monodirectional communication signal may be propagated. If the monodirectional communication signal is propagated, transmission and reception unit 34 has a transmission function and a reception function independently.

Power supply unit 44 selects one of the first drive power and the second drive power received from AC/DC conversion unit 42 and separation unit 32, respectively, and outputs the selected drive power to control unit 2 and separation unit 32 continuously. More specifically, as long as power supply unit 44 receives drive power from at least one of AC/DC conversion unit 42 and separation unit 32, power supply unit 44 can maintain control unit 2 and transmission and reception unit 34 operatively. Representatively, power supply unit 44 selectively outputs one of the first drive power and the second drive power received from AC/DC conversion unit 42 and separation unit 32, respectively, that has a higher value in voltage.

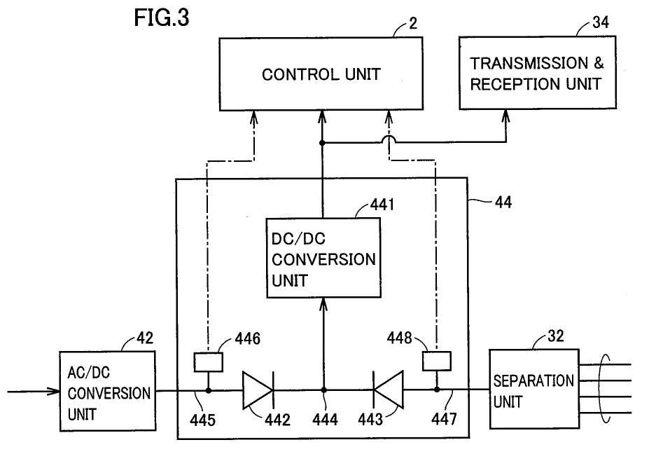

With reference to FIG. 3, in the present embodiment, power supply unit 44 includes a DC/DC conversion unit 441, diodes 442 and 443, and voltage detection units 446 and 448. DC/DC conversion unit 441 is a voltage conversion unit for maintaining at a predetermined voltage the DC drive power supplied from AC/DC conversion unit 42 or separation unit 32. Note that AC/DC conversion unit 42 and separation unit 32 provide drive powers having rated voltage values, respectively, set to be different from each other. In the present embodiment the rated voltage value of the first drive power provided from AC/DC conversion unit 42 is set to be higher than that (for example of 48 V) of the second drive power provided from separation unit 32.

Diodes 442 and 443 are countercurrent prevention devices preventing a countercurrent between AC/DC conversion unit 42 and separation unit 32. More specifically, diode 442 is inserted in a forward direction in an input line 445 extending from AC/DC conversion unit 42 to DC/DC conversion unit 441 and diode 443 is inserted in a forward direction in an input line 447 extending from separation unit 32 to DC/DC conversion unit 441. Such configuration can prevent a current flowing from AC/DC conversion unit 42 toward separation unit 32 or that flowing from separation unit 32 toward AC/DC conversion unit 42.

In addition to such countercurrent prevention function, diodes 442 and 443 fulfill a function for outputting drive power selectively. More specifically, as has been described previously, the rated voltage value of the first drive power is set to be higher than that of the second drive power. Accordingly, when AC/DC conversion unit 42 and separation unit 32 both supply their drive powers, the first drive power having the higher voltage value is selectively output. At the time, a node 444 has a voltage maintained at that of the first drive power. As such, even if the second drive power supplied from separation unit 32 is stopped, the first drive power output from power supply unit 44 is unaffected. Herein when the first drive power supplied is stopped, diode 442 transitions from the on state to the off state and diode 443 transitions from the off state to the on state. As a result the second drive power will selectively be output. As the drive powers are thus switched, node 444 has a voltage decreased to that of the second drive power. However, DC/DC conversion unit 441 operates to maintain the voltage that is supplied to control unit 2 to have a constant value, and control unit 2 and transmission and reception unit 34 thus have their respective operations unaffected.

Power supply unit 44 thus selects one of the drive powers received from AC/DC conversion unit 42 and separation unit 32 and outputs the selected drive power to control unit 2 and transmission and reception unit 34 continuously.

Furthermore, voltage detection units 446 and 448 detect the values of the voltages caused on input lines 445 and 447, respectively, and output their respective detection results to control unit 2. As will be described later, control unit 2 determines from the results the statuses of the drive powers supplied from AC/DC conversion unit 42 and separation unit 32, respectively. More specifically, voltage detection units 446 and 448 function as a status detection unit detecting the status of the first drive power and that of the second drive power.

With reference again to FIG. 2, control unit 2 includes a central processing unit (CPU) 22 performing an operation process, and a memory 24 configured for example of random access memory (RAM), read only memory (ROM) and the like.

Control unit 2 and transmission and reception unit 34 receive DC power from power supply unit 44 and operate thereon. In contrast, print engine load unit 6 including manipulation unit 62, sensor unit 64 and drive unit 66 receives the first drive power from AC/DC conversion unit 42 and operates thereon.

In particular, in the present embodiment, control unit 2 determines the statuses respectively of the drive powers based on the detection results received from voltage detection units 446 and 448 of power supply unit 44 (FIG. 3) and in accordance therewith changes a mode of operation of image formation apparatus MFP. More specifically, when AC/DC conversion unit 42 supplies the first drive power, control unit 2 enables print engine load unit 6 to operate. This is because the network power has an ability to supply power (of 15.4 W at maximum according to IEEE 802.3af), which is lower than that of the commercial power. In other words, while control unit 2 and transmission and reception unit 34 can operate on the network power (or the second drive power) alone, it is difficult for print engine load unit 6, which has a relatively large power consumption, to operate on the network power alone. Accordingly, control unit 2 enables print engine load unit 6 to operate only when sufficient drive power that can operate print engine load unit 6 is ensured.

Furthermore, when AC/DC conversion unit 42 and separation unit 32 both supply their respective drive powers, control unit 2 permits shifting to a low power consumption mode. More specifically, for example if a user does not provide any operation for a predetermined period of time, control unit 2 shifts image formation apparatus MFP to the low power consumption mode. Furthermore, control unit 2 may do so in response to an instruction entered by a user operating manipulation unit 62 to indicate that image formation apparatus MFP should be shifted to the low power consumption mode. Note that the low power consumption mode is a mode reducing image formation apparatus MFP's power consumption to be smaller than in normal operation and includes a mode setting the image formation apparatus in a standby status or a sleep status, cutting a power supply, or similarly reducing power consumption.

In this low power consumption mode control unit 2 disables print engine load unit 6 from operation. This reduces the power consumption in print engine load unit 6. Simultaneously, control unit 2 stops a power conversion operation in AC/DC conversion unit 42. As control unit 2 stops the power conversion operation in AC/DC conversion unit 42, the drive power supplied to control unit 2 and transmission and reception unit 34 is switched to the second drive power received from separation unit 32. Furthermore, stopping the power conversion operation in AC/DC conversion unit 42 can reduce a loss in the power conversion operation (a switching loss provided by a switching device representatively) and also increase the switching device and its drive circuit in longevity.

In contrast, when the commercial power supplied is interrupted and only separation unit 32 supplies the second drive power, print engine load unit 6 cannot be operated, and control unit 2 operates in a range that can at least maintain data communication with another image formation apparatus MFP or the like. More specifically, when a personal computer or the like transmits data to be printed via communication line LAN to image formation apparatus MFP together with an instruction issued to subject the data to the print process (hereinafter the data to be printed and the instruction issued to perform the print process will also be collectively referred to as a “print instruction”), control unit 2 temporarily stores the print instruction in memory 24, and after print engine load unit 6 becomes operable, control unit 2 causes the print process to be performed based on the print instruction. Such operation can prevent data transmitted from another apparatus from disappearing even if at night the commercial power supplied to image formation apparatus MFP is interrupted.

Alternatively, control unit 2 may search for another networked image formation apparatus MFP capable of the print process and transfer to that image formation apparatus MFP the print instruction stored in memory 24. Furthermore, information, such as a network address, that identifies image formation apparatuses to be searched may previously be set and a forwarding address may be selected from the image formation apparatuses to be searched that are thus previously set.

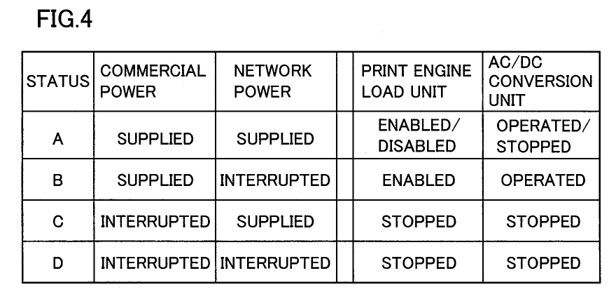

The statuses of the drive powers and that of each unit of image formation apparatus MFP in each status, as described above, will be summarized, as shown in FIG. 4.

With reference to FIG. 4, four statuses (A)-(D) are provided in accordance with what statuses the commercial power (or the first drive power) and the network power (or the second drive power) have, respectively.

In status (A), the commercial power (or the first drive power) and the network power (or the second drive power) are both supplied. In status (A) a normal mode or the low power consumption mode is selectable as a mode of operation of image formation apparatus MFP. In the normal mode, print engine load unit 6 is enabled to operate and the power conversion operation of AC/DC conversion unit 42 is performed. In the low power consumption mode, print engine load unit 6 is disabled from operation and the power conversion operation of AC/DC conversion unit 42 is stopped.

In status (B) the commercial power (or the first drive power) is supplied and the network power (or the second drive power) is interrupted. In status (B) it is necessary to continue the power conversion operation of AC/DC conversion unit 42 to supply control unit 2 and transmission and reception unit 34 with drive power and accordingly the operation of print engine load unit 6 is also enabled.

In status (C) the commercial power (or the first drive power) is interrupted and the network power (or the second drive power) is supplied. In status (C) sufficient power causing print engine load unit 6 to operate cannot be ensured, and the operation of print engine load unit 6 is stopped. Furthermore, as the commercial power is not supplied, the power conversion operation of AC/DC conversion unit 42 is also stopped.

In status (D) the commercial power (or the first drive power) and the network power (or the second drive power) are both interrupted. In status (D) image formation apparatus MFP per se is stopped.

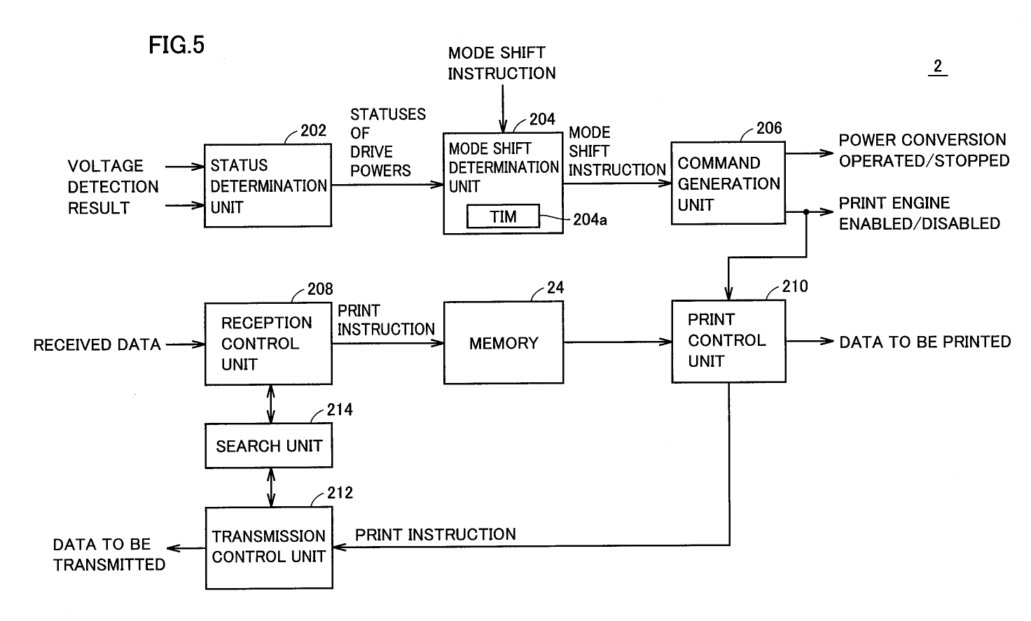

With reference to FIG. 5, in the present embodiment, control unit 2 includes a status determination unit 202, a mode shift determination unit 204, a command generation unit 206, a reception control unit 208, a print control unit 210, a transmission control unit 212, and a search unit 214 as its functions. These functions are implemented representatively by CPU 22 (FIG. 2) performing a previously stored program.

Status determination unit 202 determines from the detection results received from voltage detection units 446 and 448 of power supply unit 44 (FIG. 3) what statuses the drive powers have, respectively. More specifically, status determination unit 202 determines which one of statuses (A)-(D) shown in FIG. 4 the current status is. Note that if the current status is status (D) control unit 2 per se cannot operate and status determination unit 202 cannot determine a status of drive power. A decision made by status determination unit 202 on which one of the statuses the current status is transmitted to mode shift determination unit 204.

Mode shift determination unit 204 receives the decision from status determination unit 202. If the decision indicates status (A) mode shift determination unit 204 determines whether image formation apparatus MFP should shift to the low power consumption mode. More specifically, mode shift determination unit 204 includes a timer (TIM) 204a, which is reset whenever a user performs an operation for image formation apparatus MFP and which counts a time elapsing since the timer was reset. If the counted time exceeds a predetermined threshold time, mode shift determination unit 204 determines that image formation apparatus MFP should shift to the low power consumption mode. In other words, timer 204a counts time elapsing since the last user operation, and if there is no user operation for a predetermined period of time, image formation apparatus MFP shifts to the low power consumption mode. Or mode shift determination unit 204 shifts image formation apparatus MFP to the low power consumption mode in response to an instruction issued by a user and indicating that image formation apparatus MFP should shifts to the low power consumption mode.

Command generation unit 206 operates in response to a mode shift instruction received from mode shift determination unit 204 and indicating that image formation apparatus MFP should shift to the low power consumption mode, to disable print engine load unit 6 from operation, and generate a control signal (or a command) to stop the power conversion operation in AC/DC conversion unit 42.

Reception control unit 208 receives from transmission and reception unit 34 (FIG. 2) communication data transmitted from another apparatus toward image formation apparatus MFP and performs a communication process corresponding to that communication data. In particular, reception control unit 208 stores to memory 24 a print instruction transmitted for example from a personal computer.

Once the print instruction has been stored in memory 24, print control unit 210 determines where the print instruction should be output in accordance with the status of print engine load unit 6. More specifically, if print engine load unit 6 is enabled to operate, print control unit 210 extracts data to be printed from the print instruction stored in memory 24 and outputs that data to the print engine. If print engine load unit 6 is disabled from operation, print control unit 210 holds the data ready for output until print engine load unit 6 is enabled to operate, or transfers the print instruction to another image formation apparatus MFP. Note that it can be determined previously by a user which one of the operations print control unit 210 should perform when print engine load unit 6 is disabled from operation. If the print instruction is transferred to another image formation apparatus MFP print control unit 210 outputs to transmission control unit 212 the print instruction read from memory 24.

Transmission control unit 212 outputs to transmission and reception unit 34 (FIG. 2) communication data to be transmitted from image formation apparatus MFP toward another apparatus. In particular, transmission control unit 212 transmits the print instruction received from print control unit 210, to image formation apparatus MFP to which the print instruction should be transferred, as determined by search unit 214, which will be described hereinafter.

Search unit 214 searches for another networked image formation apparatus MFP that is capable of the print process. More specifically, search unit 214 broadcasts a search message in a network via transmission control unit 212 for searching for an image formation apparatus capable of the print process. If any image formation apparatus MFP responds to the search instruction and returns a response message, search unit 214 receives the response message via reception control unit 208, and in accordance with the response message identifies the image formation apparatus capable of the print process and transmits to transmission control unit 212 the information indicating that the image formation apparatus capable of the print process has been identified.

In accordance with that information, transmission control unit 212 transfers the print instruction received from print control unit 210.

By the functional configuration as described above, control unit 2 implements each process according to the present embodiment.

Process Flow

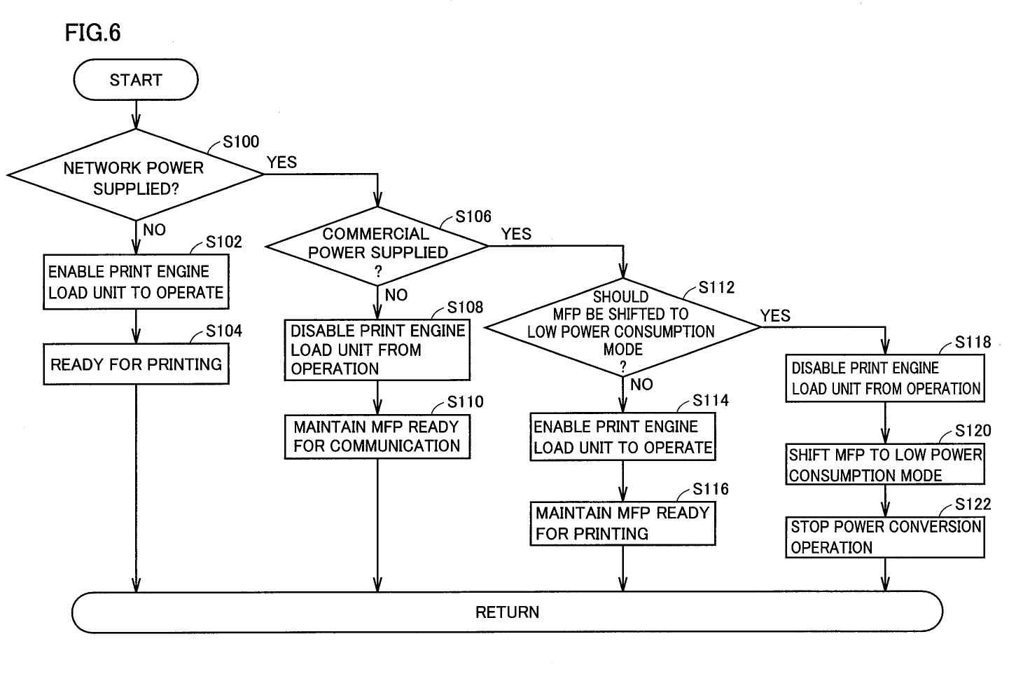

FIG. 6 is a flowchart of a procedure of a process performed in the image formation apparatus according to the present embodiment. Such process is implemented by the control unit 2 CPU 22 performing a program stored for example in memory 24. Note that the FIG. 6 flowchart is performed periodically, as predetermined, (for example a period of hundreds msec) repeatedly when image formation apparatus MFP is operative, i.e., receives at least one of the commercial power and the network power.

With reference to FIG. 6, CPU 22 determines from a detection result received from voltage detection unit 448 of power supply unit 44 (FIG. 3) whether separation unit 32 supplies the second drive power, i.e., whether the network power is supplied (step S100). If not (NO at S100) CPU 22 enables print engine load unit 6 to operate (step S102) and maintains image formation apparatus MFP ready for printing (step S104). While image formation apparatus MFP is thus ready for printing, image formation apparatus MFP is capable of a print process based on a document read by its image reading unit 8 and is also capable of a print process in accordance with a print instruction issued for example from a personal computer. Note that in this case, only AC/DC conversion unit 42 (FIG. 2) supplies the first drive power and the power conversion operation in AC/DC conversion unit 42 cannot be stopped. The process then returns to the start.

If the network power is supplied (YES at S100) CPU 22 determines from a detection result received from voltage detection unit 446 of power supply unit 44 (FIG. 3) whether AC/DC conversion unit 42 supplies the first drive power, i.e., whether the commercial power is supplied (step S106).

If not (NO at S 106) CPU 22 disables print engine load unit 6 from operation (step S108) and maintains image formation apparatus MFP ready for communication (step S110). When image formation apparatus MFP is thus ready for communication, it is incapable of the print process. However, control unit 2 and transmission and reception unit 34 are in operation, and data communication with another apparatus such as a personal computer is maintained. Furthermore, when a print instruction is received for example from a personal computer, the print instruction is stored to memory 24. The process then returns to the start.

In contrast, if the commercial power is supplied (YES at S106) CPU 22 determines whether image formation apparatus MFP should be shifted to the low power consumption mode (step S112). If not (NO at S112) CPU 22 enables print engine load unit 6 to operate (step S114) and maintains image formation apparatus MFP ready for printing (step S116). When image formation apparatus MFP is thus ready for printing, image formation apparatus MFP is capable of a print process based on a document read by its image reading unit 8 and is also capable of a print process in accordance with a print instruction issued for example from a personal computer. The process then returns to the start.

In contrast, if CPU 22 determines that image formation apparatus MFP should be shifted to the low power consumption mode (YES at S112) CPU 22 disables print engine load unit 6 from operation (step S118) and shifts image formation apparatus MFP to the low power consumption mode (step S120). CPU 22 then stops the power conversion operation in AC/DC conversion unit 42 (step S122). Subsequently the process returns to the start.

Note that at step S102 or S114 after print engine load unit 6 is enabled to operate the print process may be performed automatically in accordance with the print instruction stored in memory 24.

Application

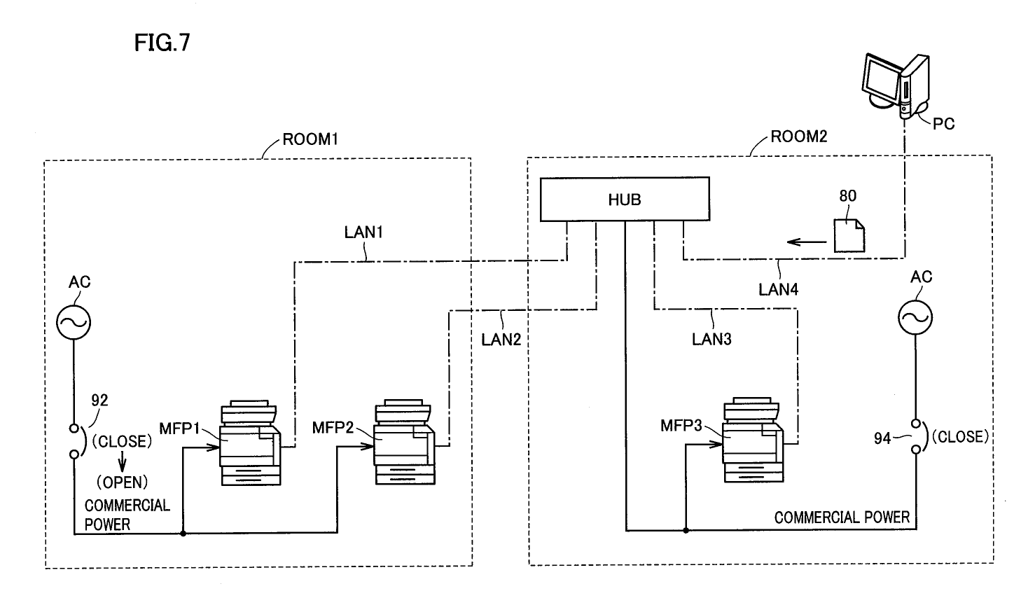

With reference to FIG. 7, for the sake of illustration, an office has a room 1 in which a user does his/her work for his/her business hours and a room 2 in which some service is continuously provided even before and/or after the business hours. Representatively, room 2 is for example a server room accommodating a server device. In room 1, two image formation apparatuses MFPs 1 and 2 are installed. They receive commercial power from power supply system AC via a breaker 92. Furthermore, in room 2, one image formation apparatus MFP3 and hub device HUB are installed. They receive commercial power from power supply system AC via a breaker 94.

Image formation apparatuses MFPs 1-3 are connected to hub device HUB via communication lines LANs 1-3, respectively. As has been described previously, hub device HUB is equipped with a power supplying function, and supplies power to image formation apparatuses MFPs 1-3 via communication lines LANs 1-3, respectively.

Furthermore a personal computer PC is connected to hub device HUB via a communication line LAN4. Personal computer PC functions for example as a gateway of Internet fax. When personal computer PC receives facsimile data from a sender, personal computer PC transmits a print instruction 80 that is based on the facsimile data for example to image formation apparatus MFP1. Image formation apparatus MFP1 receives print instruction 80 and performs a print process in accordance with print instruction 80.

Herein, to reduce power consumption in room 1, a system is discussed that stops power supplied to room 1 after all users have left room 1. More specifically, once all users have left room 1, breaker 92 is opened. In such a case, a conventional image formation apparatus would completely stop operation, and personal computer PC cannot communicate data with the conventional image formation apparatus.

In the present embodiment, in contrast, if commercial power supply supplied is interrupted, image formation apparatus MFP1 can employ the network power supplied from hub device HUB to maintain a data communication function. Image formation apparatus MFP1 can thus receive print instruction 80 from personal computer PC. Image formation apparatus MFP1 stores the received print instruction 80 to memory, and when a user enters room 1 and supplying the commercial power supply is resumed, image formation apparatus MFP1 performs a print process in accordance with the stored print instruction 80, or when print instruction 80 is received with the commercial power supply interrupted, image formation apparatus MFP1 transfers print instruction 80 to image formation apparatus MFP3 installed in room 2. Image formation apparatus MFP3, which is constantly supplied with the commercial power, performs a print process in accordance with print instruction 80 transferred from image formation apparatus MFP1.

Thus the present embodiment provides image formation apparatus MFP that can establish both reducing power consumed in the entirety of a particular room and being constantly capable of receiving data transmitted from an external device at any time.

In accordance with the present embodiment image formation apparatus MFP is configured to be capable of receiving the two external powers of commercial power provided for example from a power supply system and network power supplied via a communication line, and uses one of the two external powers to maintain a data communication function. Thus if the commercial power provided from the power supply system is interrupted image formation apparatus MFP can still continue to communicate data with another apparatus. Furthermore, image formation apparatus MFP stores to memory the data transmitted when commercial power supply supplied is interrupted, and when the commercial power supply interrupted is resumed, image formation apparatus MFP performs a print process in accordance with that stored data. Even if power supplied to the entirety of the room having image formation apparatus MFP installed therein is interrupted for the purpose of reducing power consumption, image formation apparatus MFP is not prevented from communicating data with another apparatus.

Furthermore in accordance with the present embodiment when the commercial power and the network power are both received, and a predetermined condition is also satisfied, image formation apparatus MFP shifts to a low power consumption mode. In the low power consumption mode, print engine load unit 6 is disabled from operation, which can reduce power consumed in print engine load unit 6. Simultaneously, a power conversion operation performed in AC/DC conversion unit 42 can also be stopped. This can reduce a loss in the power conversion operation and increase a switching device configuring AC/DC conversion unit 42 and its drive circuit in longevity.

In the above described embodiment the present image formation apparatus has been described as an MFP equipped with a plurality of functions such as a copy function, a print function, a facsimile function and a scanner function by way of example. However, the present image formation apparatus is not limited thereto. It may for example be a digital copier, a printer, a facsimile device and the like having a network communication function.

Furthermore, print engine load unit 6 is illustrated representatively as manipulation unit 62, sensor unit 64 and drive unit 66. However, print engine load unit 6 is not necessarily required to include all of them; for example, manipulation unit 62 may be excluded from print engine load unit 6.

Although the present invention has been described and illustrated in detail, it is clearly understood that the same is by way of illustration and example only and is not to be taken by way of limitation, the scope of the present invention being interpreted by the terms of the appended claims.

What is claimed is:

1. An image formation apparatus configured to be capable of communicating data via a communication line with an external device capable of supplying power via said communication line, comprising:
a power load unit for performing a process involved in forming an image;
a control unit controlling said power load unit;
a power conversion unit converting external power received from an external power source into first drive power;
a separation unit connected to said communication line, and separating a communication signal and supplied power flowing through said communication line, and outputting said supplied power separated as second drive power;
a transmission and reception unit transmitting and receiving said communication signal; and
a power supply unit continuously supplying at least said control unit and said transmission and reception unit with one of said first drive power and said second drive power.

2. The image formation apparatus according to claim 1, wherein said power supply unit selects and outputs one of said first drive power and said second drive power that has a higher voltage value.

3. The image formation apparatus according to claim 2, wherein:
said power supply unit includes
a voltage conversion unit converting one of said first drive power and said second drive power to a predetermined voltage,
a first diode provided in a path inputting said first drive power to said power conversion unit, said first diode being provided in a forward direction, and
a second diode provided in a path inputting said second drive power to said power conversion unit, said second diode being provided in a forward direction; and
said first drive power has a rated voltage value higher than that of said second drive power.

4. The image formation apparatus according to claim 1, wherein:
said power supply unit further includes a status detection unit detecting a status of said first drive power and that of said second drive power; and
said control unit changes a mode of operation of the image formation apparatus in accordance with said status of said first drive power and that of said second drive power.

5. The image formation apparatus according to claim 4, wherein:
said power load unit is configured to be operable on said first drive power provided from said power supply unit; and
said control unit enables said power load unit to operate when said first drive power is supplied.

6. The image formation apparatus according to claim 4, wherein when said first drive power and said second drive power are both supplied, said control unit permits shifting to a low power consumption mode, and after shifting to said low power consumption mode, stops a power conversion operation in said power conversion unit.

7. The image formation apparatus according to claim 4, wherein:
said control unit includes a storage unit storing data; and
when said transmission and reception unit receives a print instruction via said communication line and said first drive power is also supplied said control unit enables said power load unit to operate to perform the process in accordance with said print instruction, whereas when said transmission and reception unit receives said print instruction via said communication line and said first drive power is not supplied said control unit stores said print instruction to said storage unit.

8. The image formation apparatus according to claim 7, wherein:
the image formation apparatus is connected to be capable of communicating data with another image formation apparatus via said communication line; and
when said print instruction is stored in said storage unit, said control unit conducts a search for said other image formation apparatus connected to be capable of communicating data that is capable of an image formation process, and said control unit transfers said print instruction stored in said storage unit to the image formation apparatus retrieved by said search.

9. A control method performed in an image formation apparatus configured to be capable of communicating data via a communication line with an external device capable of supplying power via said communication line, said image formation apparatus including:
a power load unit for performing a process involved in forming an image;
a power conversion unit converting external power received from an external power source into first drive power;
a control unit controlling said power load unit;
a separation unit connected to said communication line, and separating a communication signal and supplied power flowing through said communication line, and outputting said supplied power separated as second drive power;
a transmission and reception unit transmitting and receiving said communication signal; and
a power supply unit continuously supplying at least said control unit and said transmission and reception unit with one of said first drive power and said second drive power, said method comprising the steps of:
obtaining by said control unit a status of said first drive power and that of said second drive power; and
changing by said control unit a mode of operation of said image formation apparatus in accordance with said status of said first drive power and that of said second drive power.

10. The control method according to claim 9, wherein:
said power load unit is configured to be operable on said first drive power provided from said power supply unit; and
the step of changing includes the step of enabling said power load unit to operate when said first drive power is supplied.

11. The control method according to claim 9, wherein the step of changing includes the step of permitting shifting to a low power consumption mode when said first drive power and said second drive power are both supplied, and after said shifting to said low power consumption mode, stopping a power conversion operation performed by said power conversion unit.

12. The control method according to claim 9, wherein:
said control unit includes a storage unit storing data; and
the control method further comprises the step of enabling said power load unit to operate to perform the process in accordance with a print instruction when said transmission and reception unit receives said print instruction via said communication line and said first drive power is also supplied, whereas storing said print instruction to said storage unit when said transmission and reception unit receives said print instruction via said communication line and said first drive power is not supplied.

13. The control method according to claim 12, wherein:
said image formation apparatus is connected to be capable of communicating data with another image formation apparatus via said communication line; and
the control method further comprises the step of, when said print instruction is stored in said storage unit, conducting a search for said other image formation apparatus connected to be capable of communicating data that is capable of an image formation process, and transferring said print instruction stored in said storage unit to the image formation apparatus retrieved by said search.
